(19) United States
(12) Patent Application Publication
(10) Pub. No.: US 2010/0320023 A1
(43) Pub. Date: Dec. 23, 2010

(54) FOUR WHEEL VEHICLE HAVING A ROTATABLE BODY SECTION AND METHOD THEREFOR

(76) Inventor: Michael Rhodig, Scottsdale, AZ (US)

Correspondence Address: WEISS & MOY PC, 4204 NORTH BROWN AVENUE, SCOTTSDALE, AZ, 85251, US

(21) Appl. No.: 12/490,227

(22) Filed: Jun. 23, 2009

(51) Int. Cl. B62D 21/02; B62D 7/16

(52) U.S. Cl. 180/400; 180/311

(57) ABSTRACT

A motorized vehicle has a frame. A rotational section is coupled to the frame. An axle assembly is coupled to the frame. A steering system is coupled to the axle assembly. The steering system has a flexible joint to adjust the steering assembly as the rotational section rotates in one of a clockwise or counterclockwise direction. An engine is coupled to the axle assembly.

### FIELD OF THE INVENTION

This invention relates to motorized vehicles and, more specifically, to a vehicle that combines the characteristics of motorcycles, in terms of handling/steering, with the stability and safety of four-wheeled vehicles.

### BACKGROUND OF THE INVENTION

Presently, it is well known that in the field of vehicles a substantial diversification of models has been proposed. In particular, there is a growing interest towards “hybrid” vehicles that combine the characteristics of motorcycles, in terms of handling, with the stability of four-wheeled vehicles. Such vehicles are, for example, represented by four-wheeled vehicles known commercially by the name quad (quadricycle) or ATV (All Terrain Vehicle). Recently, a new class of 3-wheeled motorcycles have come out. These 3-wheeled motorcycles have two wheels in front and one at the rear.

Most ATVs have two or more back wheels, usually two front wheels, an open driver's seat and a motorcycle-type handlebar. ATVs are often used off-road for recreation and utility. Recreational ATVs are generally small, light, two-wheel-drive vehicles, whereas utility ATVs are generally bigger four-wheel-drive vehicles with the ability to haul small loads on attached racks or small dump beds. Utility ATVs may also tow small trailers. Utility ATVs with 6 wheels include an extra set of wheels at the back to increase the payload capacity, and can be either four-wheel-drive (back wheels driving only) or six-wheel-drive.

One main problem with ATVs is the inability to provide the rider with a true feeling of riding a motorcycle. More specifically, the rider of an ATV will not be able to lean the ATV into a turn by leaning one's body (known as body steering) like one can do when riding a motorcycle. When one tries to lean into a turn while riding an ATV, the suspension on the ATV pushes against the rider. Thus, body steering, and the feeling of leaning into a turn as with riding a motorcycle cannot be truly realized when riding current ATVs and other three or four wheel motorized vehicles.

Therefore, a need existed to provide a system and method to overcome the above problem. The system and method would provide a four wheeled vehicle that provides the feeling of riding a motorcycle.

### SUMMARY OF THE INVENTION

A motorized vehicle has a frame. A rotational section is coupled to the frame. An axle assembly is coupled to the frame. A steering system is coupled to the axle assembly. The steering system has a flexible joint to adjust the steering assembly as the rotational section rotates in one of a clockwise or counterclockwise direction. An engine is coupled to the axle assembly.

A motorized vehicle has a frame unit having a first end member and a second end member. A rotational section is coupled to the frame. The rotational section comprises: an inner structure having a first end coupled to a first end of the frame and a second end coupled to a second end of the frame; a plurality of roller races attached to the inner structure; and an outer structure placed over the inner structure and in contact with the roller races, the outer structure rotating about the inner structure. An axle assembly is coupled to the frame. A suspension system is coupled to the frame and the axle assembly. A steering system is coupled to the axle assembly. The steering system has a flexible joint to adjust the steering assembly as the rotational section rotates in one of a clockwise or counterclockwise direction. An engine is coupled to the axle assembly. A body section is coupled to the rotational section.

A motorized vehicle has a frame unit having a first end member and a second end member. A rotational section is coupled to the frame. The rotational section comprises a cradle structure having a first end rotatably coupled to a first end of the frame and a second end rotatably coupled to a second end of the frame. An axle assembly is coupled to the frame. A suspension system is coupled to the frame and the axle assembly. A steering system is coupled to the axle assembly. The steering system has a flexible joint to adjust the steering assembly as the rotational section rotates in one of a clockwise or counterclockwise direction. An engine is coupled to the axle assembly. A body section is coupled to the rotational section.

The present invention is best understood by reference to the following detailed description when read in conjunction with the accompanying drawings.

### BRIEF DESCRIPTION OF THE DRAWINGS

FIG. 1 is an elevated perspective view of the vehicle of the present invention;

FIG. 2 is a rear view of the vehicle of the present invention;

FIG. 3 is a side view of the vehicle of the present invention with the shell of the body removed showing the inner body member of the rotational section of the frame;

FIG. 4 is a side view of the vehicle of the present invention with the shell of the body section removed showing a more detailed view of the frame having a battery storage area;

FIG. 5 is rear view of the vehicle of the present invention with the shell removed showing the frame and the rear suspension;

FIG. 6 is an exploded cross-sectional view of the frame of the present invention;

FIG. 7 is a cross-sectional view of the frame of the present invention showing the battery storage area and the seating area;

FIG. 8 is a top view of the vehicle of the present invention with the shell of the body removed showing the inner body member of the rotational section of the frame;

FIG. 9 is a top view of the vehicle of the present invention with the shell of the body removed showing a more detailed view of the frame;

FIG. 10 is a top view of another embodiment of the vehicle of the present invention with the shell of the body installed and showing the front suspension;

FIG. 11 is a side view of the vehicle depicted in FIG. 10 with the shell of the body installed showing rotational body section and the steering system; and

FIG. 12 is a rear view of the vehicle depicted in FIG. 10 showing the frame ad rear suspension in more detail.

Common reference numerals are used throughout the drawings and detailed description to indicate like elements.

### DETAILED DESCRIPTION

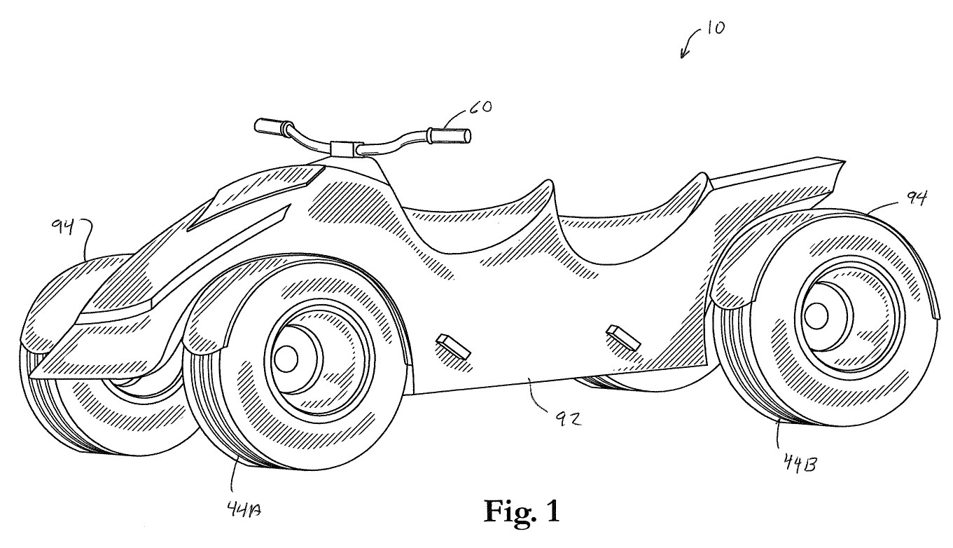

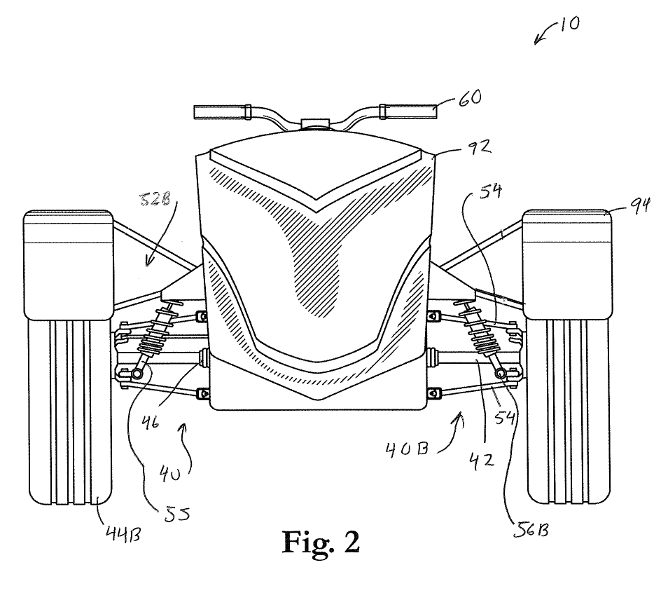

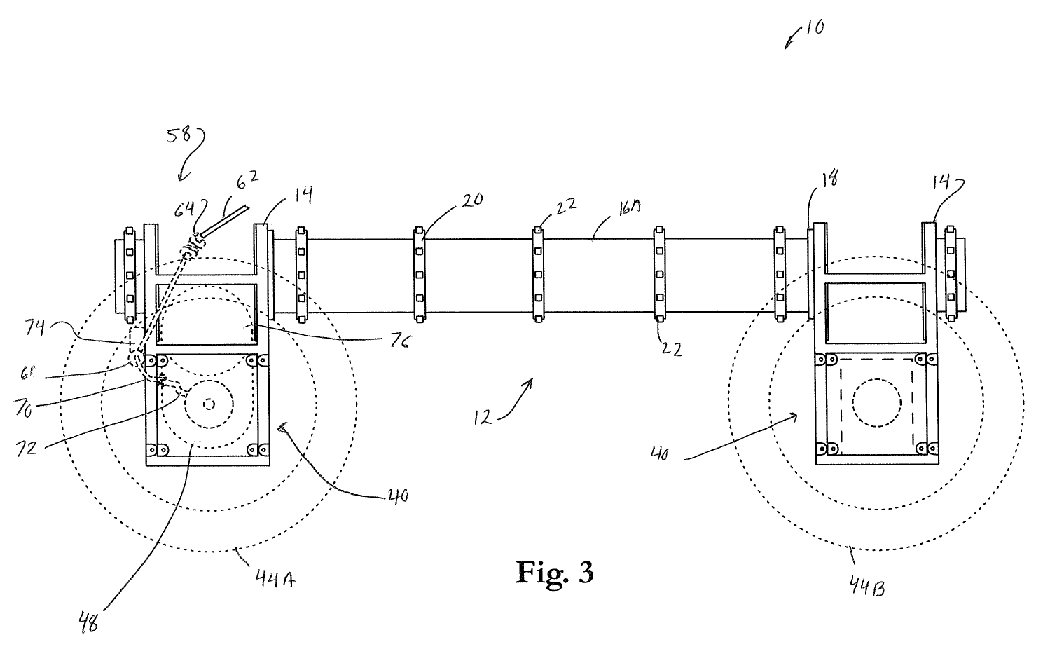

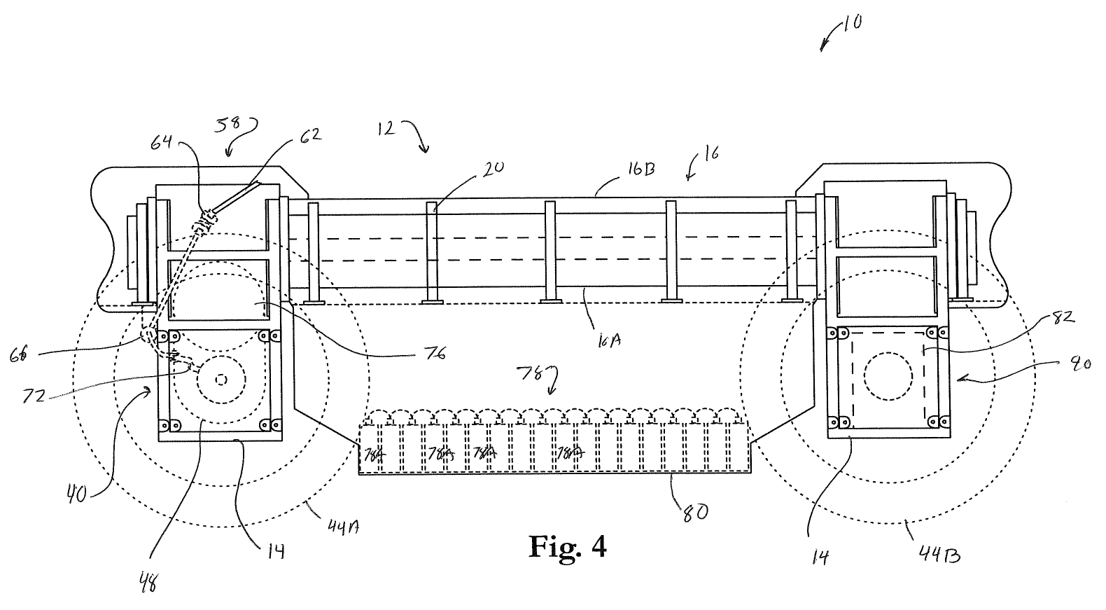

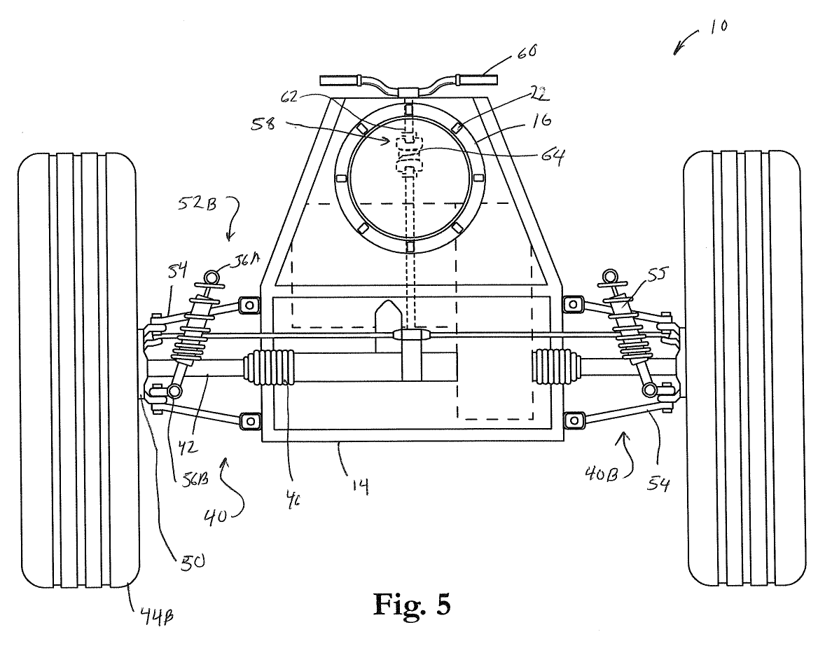

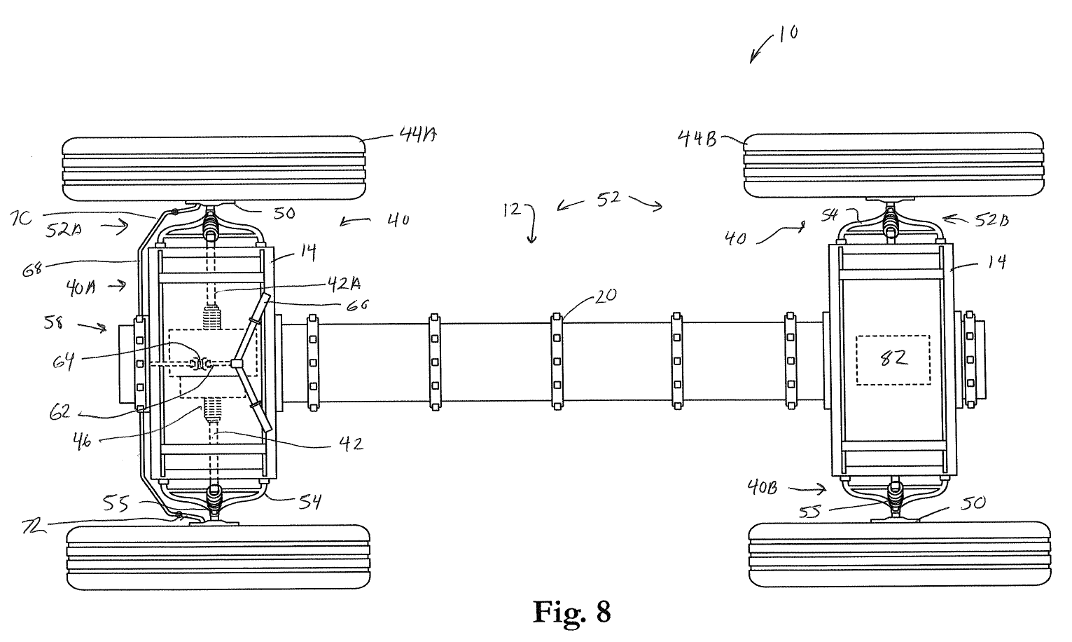

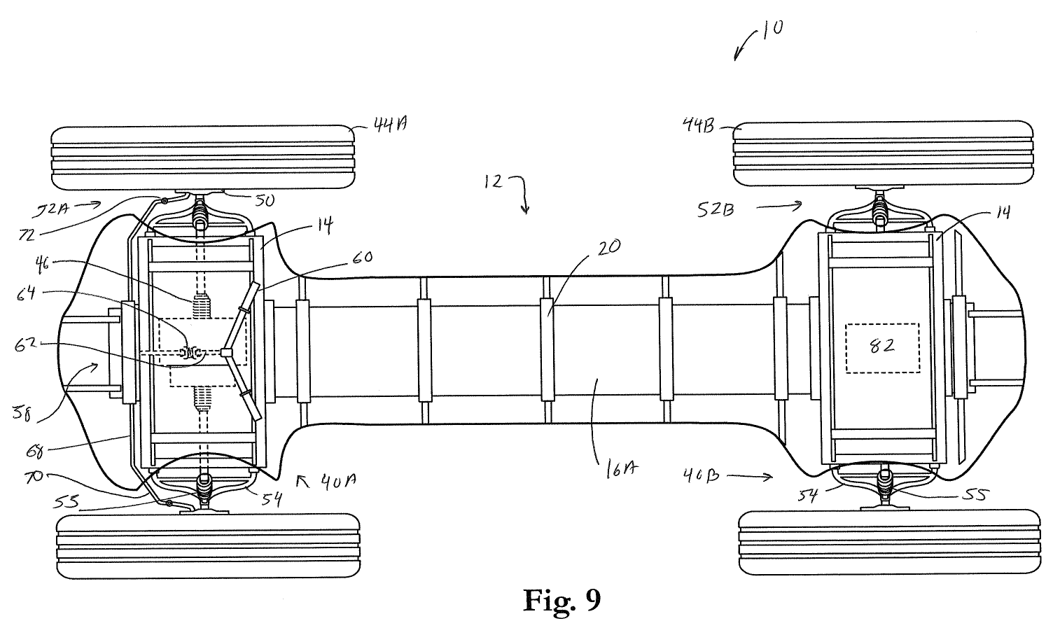

Referring to FIGS. 1-9, a motorized vehicle 10 (hereinafter vehicle 10) is shown. The vehicle 10 is a four wheeled vehicle that provides the feeling of riding a motorcycle. The vehicle 10 allows one to lean one's body while turning similar to what one can do when riding a motorcycle. This is accomplished by virtue of the pendulum effect of a weighted battery compartment when subjected to the forces of the turning vehicle 10.

The vehicle 10 has a main frame unit 12. The main frame unit 12 has a pair of end members 14. In accordance with one embodiment, the end members 14 area pair of H-frame member. However, this is only given as an example and should not be seen as to limit the scope of the present invention.

A rotational body section 16 is coupled to and positioned between the pair of end members 14. A connector 18 is used to secure the end of the rotational body section 16 to the end members 14. The rotational body section 16 is coupled to and positioned between the pair of end members 14 so as to rotate about the main frame unit 12. This allows one to lean one's body while turning the vehicle 10 similar to what one can do when riding a motorcycle. The rotational body section 16 will rotate in a clockwise or counterclockwise direction as a rider lean his/her body while turning the vehicle 10. In accordance with one embodiment, the rotational body section 16 may be limited to rotate no more that approximately + or −45° in a clockwise or counterclockwise direction. However, this should not be seen as to limit the scope of the present invention. The vehicle 10 may be designed to possibly swing approximately + or −90°.

The rotational body section 16 may be formed in different manners. For example, the rotational body section 16 may be formed of a tubular structure which is rotationally coupled to and positioned between the pair of end members 14. In this embodiment, the connector 18 is a rotational connector or the like which may be used to secure the end of the rotational body section 16 to the end members 14 and to allow the rotational body section 16 to rotate.

In accordance with the embodiment shown in FIGS. 1-9, the rotational body section 16 is formed of an inner body member 16A. The inner body member 16A is coupled to and positioned between the pair of end members 14. In this embodiment, the connector 18 is a flange or other type of connector which is used to secure the end of the rotational body section 16 to the end members 14. In the present embodiment, the inner body member 16A is a circular tube member. However, this is shown as only one embodiment. The inner body section 16 may take on different shapes and forms without departing from the spirit and scope of the present invention.

The inner body member 16A may have a plurality of roller races 20 running a length of the inner body member 16A. The roller races 20 provide a mechanism wherein an outer body member 16B may be able to rotate about the inner body member 16A. Each roller race 20 may be approximately equally distant to an adjacent roller race 20.

In accordance with one embodiment, each roller race 20 may be comprised of a plurality of rollers 22 formed around an outer perimeter of the inner body member 16A. Each roller 22 may have a housing 24 attached to an exterior surface of the inner body member 16A. The housing 24 may be a metal assembly, rig, harness or fork that encases or holds a wheel 26. The wheel 26 may be held in place by an axle 28 between two legs of the housing 24. Each roller 22 may be approximately equally spaced from an adjoining roller 22 and the axle 28 of each roller 22 of a respective roller race 20 will generally be along the same circumferal line 30. Alternatively, each roller race 20 may be a ball thrust bearing, roller thrust bearing or the like. The listing of the above is given as examples and should not be seen as to limit the scope of the present invention.

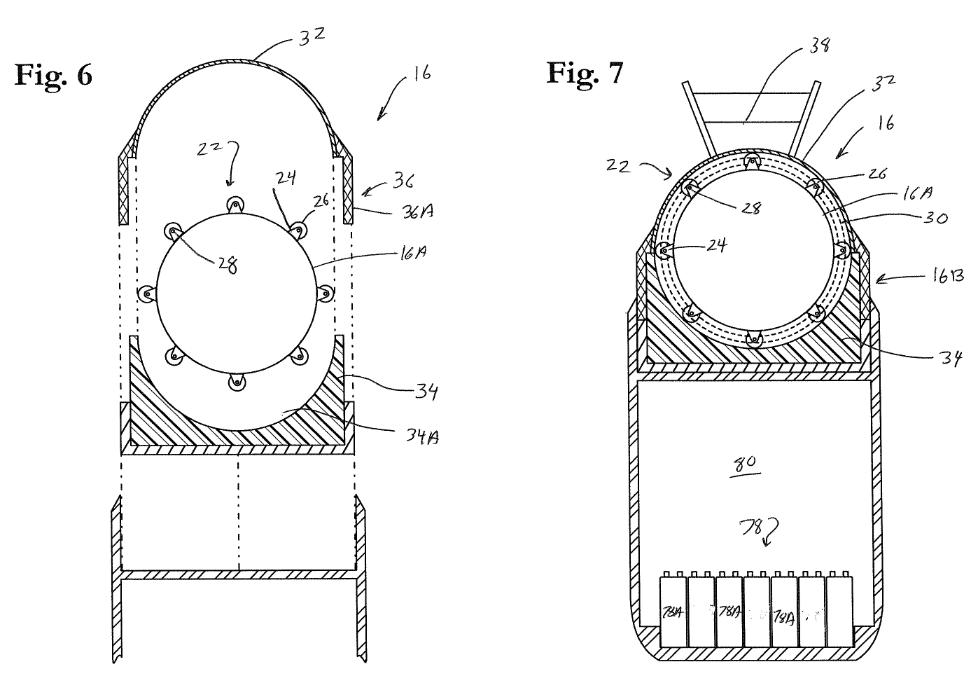

The outer body member 16B is positioned to rotate about the inner body member 16A. In accordance with one embodiment as shown more clearly in FIGS. 6-7, the outer body member 16B may be comprised of a saddle member 32 and a saddle brace 34. The saddle brace 34 may be coupled to the main frame unit 12. The saddle member 32 and the saddle brace 34 are connected to the main frame unit 12 via the rollers 22 of the roller race 20. The saddle member 32 and the saddle brace 34 join together to form a tube around the rollers 22 which are supported by the inner body member 16A. 34 does not support 16A. In accordance with one embodiment, the saddle member 32 and the saddle brace 34 may form circular cavity 34A. The above is only given as an example and should not be seen as to limit the scope of the present embodiment.

In order to attach the saddle member 32 and the saddle brace 34, a flange 36 may be used. In accordance with one embodiment, the flange 36 has end members 36A which extend downward from the saddle member 32. The end members 36A contact the side of the saddle brace 34 thereby providing a mechanism to couple the saddle member 32 and the saddle brace 34 together.

In general, the saddle member 32 may be positioned over an upper section of the inner body member 16A and the saddle brace 34 may be positioned on a bottom section of the inner body member 16A. An interior surface of the saddle member 32 and the saddle brace 34 may be in contact with the roller races 20. In the embodiment shown in FIGS. 6-7, the saddle member 32 and the saddle brace 34 engage the wheels 26 of the rollers 22. This allows the saddle member 32 and the saddle brace 34 to rotate about the inner body member 16A.

Body support members 38 may be coupled to the saddle member 32. The body support members 38 support the front and rear body parts and connect them to the rotating body 16B via the saddle member 32. The body support members 38 rotate with the rider as the saddle member 32 and the saddle brace 34 rotate about the inner body member 16A. This allows one to lean one's body while turning similar to what one can do when riding a motorcycle.

Axle assemblies 40 may be coupled to the main frame unit 12. The axle assemblies 40 may be a straight axle or a split-axle design. In the embodiment shown in FIGS. 1-9, a split-axle design is used. The split-axle design allows for independent suspension of the left and right wheels. A split axle further permits the use of a differential, allowing the left and right drive wheels to be driven at different speeds, improving traction and extending tire life.

In the embodiment shown in FIGS. 1-9, the axle assembly 40 may have a front axle assembly 40A and a rear axle assembly 40B coupled to the main frame unit 12. The front axle assembly 40A may have a pair of output axle shafts 42 wherein each output axle shaft 42 has a first end which extends to a drive wheel 44A. In general, the drive wheel 44A may be coupled to a wheel hub 50 which may be formed on the first end of the output axle shafts 42. The output axle shafts 42 may be contained in respective non-rotating hollow, elongated axle arm sections 46 which may be secured to the end member 14 of the main frame unit 12.

The second end of each output axle shafts 42 may be connected to a transaxle unit 48. In the embodiment shown in FIGS. 1-9, the transaxle unit 48 may be coupled to a bottom section of the end member 12 positioned in the front of the vehicle 12. The transaxle unit 48 may be a unit combining the transmission and differential and connected directly to each output axle shaft 42 which extends to the drive wheels 44A. Thus, the rotation of the differential by the transmission causes a corresponding rotation of the output axle shafts 42 of the front axle assembly 40A.

The rear axle assembly 40B may have a pair of output axle shafts 42 wherein each output axle shaft 42 may have a first end which extends to a wheel 44B. The wheel 44B may be coupled to a wheel hub 50 which is formed on the first end of the output axle shafts 42. The output axle shafts 42 may be contained in non-rotating hollow, elongated axle arm sections 46 which are secured to the end member 14 of the main frame unit 12. While the present embodiment shows front wheel drive with the front axle assembly 40A as the drive unit, this should not be seen in a limiting scope. The vehicle 10 may be a rear wheel drive vehicle with the rear axle assembly 40B as the drive unit. Further, the vehicle 10 may be a four wheel drive vehicle with the both the front and rear axle assemblies 40A and 40B coupled to the transaxle unit 48 or by adding a second drive motor/transaxle assembly coupled to the rear axle assembly 40B.

A suspension system 52 is coupled to the main frame unit 12. The suspension system 52 will maximize the friction between the wheels 44A and 44B and the road surface, to provide steering stability with good handling and to ensure the comfort of those in the vehicle 10. Since the suspension system 52 is independent of and not directly connected to the rotational body section 16, when a rider leans in the seat 38 of the vehicle 10, the suspension system 52 will not resist the motion of the rider like in current ATVs.

Different types of suspension systems may be used with the vehicle 10. In accordance with the embodiment shown in FIGS. 1-9, the suspension system 52 has a front suspension unit 52A and a rear suspension unit 52B. The front suspension unit 52A and the rear suspension unit 52B may be dependent or independent suspension units. In the embodiment shown in FIGS. 1-9, the front suspension unit 52A and the rear suspension unit 52B are independent suspension units. Thus the wheels 44A and 44B are allowed to move independently from one another.

In the present embodiment shown, the front suspension unit 52A and the rear suspension unit 52B may each be coupled to a respective end member 14. The front suspension unit 52A and the rear suspension unit 52B may each have a plurality of control arm members 54. The control arm members 54 may be A-frame members or the like. However, the listing is only given as an example and should not be seen as to limit the scope. First ends of a pair of control arm member 54 may be attached to each side of each end member 12 of the main frame unit 10. The first ends of the pair of control arm member 54 may be attached to each side of each end member 12 so that an output axle shaft 42 is positioned between the pair of control arm member 54. The send end of the pair of control arm members 54 may be attached to the wheel hub 50 of the output axle shaft 42.

The front suspension unit 52A and the rear suspension unit 52B may further have shock absorbers 55. The shock absorbers 55 may be used to smooth out or damp shock impulse, and dissipate kinetic energy. Each shock absorber 55 may have a pair of mounts 56, an upper mount 56A and a lower mount 56B. The upper mount 56A of the shock absorber 54 may be attached to the main frame unit 12 and the lower mount 56B may be attached to the axle assembly 40.

The vehicle 10 may have a steering system 58. Different types of steering systems may be used. For example, the steering system 58 may be a rack and pinion steering system, a recirculating-ball steering system, or the like. The listing of the above is given as an example and should not be seen as to limit the scope of the present invention.

In general, the steering system 58 may have a gripping device 60. The gripping device 60 may be held and controlled by the rider and used to turn the vehicle 10. In general, the gripping device 60 may be handlebars, a steering wheel, a lever or other similar devices. The listing of the above is given as an example and should not be seen in a limiting scope.

The gripping device 60 may be coupled to a steering column 62. The steering column 62 may have a first end coupled to the gripping device 60. A second end of the steering column 62 may be coupled to a flex joint 64. The flex joint 64 may allow the steering column 62 to move as the rider leans in a clockwise or counterclockwise direction in the seat 38 so that the outer body member 16B rotates about the inner body member 16A. The flex joint 64 mat be similar to CVX series universal joint sold by Cornay®.

A gear system 66 may be coupled to the other end of the flex joint 64. The gear system 66 may allow one to more easily turn the steering system 58. The gear system 66 may be a rack and pinion, a recirculating ball gearbox or the like. The gear system 66 may be coupled to a rod member 68. The distal end of the rod member 68 may have tie rod 70. The tie rod 70 transmits force from the gear system 66 to a steering link 72. This will cause the wheels 44A, which are coupled to the steering link 72 via the front axle assembly 40A to turn.

In accordance with one embodiment, the steering system 58 may be a power steering system. Power steering is a system for reducing the steering effort on the vehicle by using an external power source to assist in turning the wheels 44A. A hydraulic pump 74 may be coupled to the gear system 66. The hydraulic pump applies a force to the gear system 66, which in turn applies a torque to the steering links of the wheels 44A.

The hydraulic pump 74 may be driven by the engine 76 of the vehicle 10 via a belt and pulley. Alternatively, an Electrically Powered Hydraulic Steering (EPHS) unit may be used. EPHS is an electrically assisted steering solution, which allows a conventional hydraulic steering system to run without an engine driven hydraulic pump. EPHS is a system designed by TRW®.

The vehicle 10 may be driven by an engine 76. The engine 76 may be attached to the main frame unit 12. In the present embodiment, the engine 76 is attached to the end member 14 of the main frame unit 12. The engine 76 is coupled to the transaxle unit 48 and used to power and rotate the drive wheels 44A. The engine 76 may be a combustion engine.

In the embodiment shown in FIGS. 1-9, the engine 76 may be an electric engine. The engine 76 may be powered by a battery pack 78. The battery pack 78 may be formed of a plurality of battery units 78A. The plurality of battery units 78A may be stored in a battery box compartment 80. The battery box 80 may form part of the rotational body section 16 and rotates with the seat and rider. The weight of the battery pack 78 causes the rotational body section 16 to have a stabilized design. The forces of gravity and turning acting on the center of gravity of the rotational body section 16 including the rider, will combine into a single force vector acting on this combined center of gravity and parallel to the vertical axis. In the present embodiment, the battery box compartment 80 is formed on a bottom section of the rotational body section 16.

In the present embodiment, the center of gravity of the rider and saddle is below the axis of rotation, and will always align itself with the force vector acting upon it. In order to create a center of gravity below the axis of rotation, ballast is required. Thus, the battery pack 78 is of considerable weight, and that weight remains constant regardless of energy present. To turn the vehicle 10, the rider turns the wheels exactly as he would while riding a motorcycle, but the rider's position will lean into the turn all on its own according to the force vector acting on the center of gravity.

The vehicle 10 may have a power control module (PCM) 82. The PCM 82 may be coupled to the engine 76 and the battery pack 78. The PCM 82 may be used to control the power being delivered from the battery pack 78 to the engine 76. The PCM 82 reads the setting of an accelerator pedal 84 from a potentiometer and regulates the power accordingly.

The vehicle 10 may have a braking system. The braking system may be any type of braking system. The braking system may be of drum brake system, a disc brake system, or the like. The listing of the above is given as an example and should not be seen as to limit the scope of the present invention. The braking system may have an actuating device. The actuating device may be a pedal, hand grip, or the like. When the actuating device is pressed, a force is transmitted to a braking mechanism located on the axle assembly 40.

A body unit 92 may be placed on the vehicle 10. The body unit 92 may be used to enclose the components of the vehicle 10. The body unit 92 may be made out different types of material such as metal, fiberglass, carbon fiber, and the like. The body unit 92 may also be designed with different shapes to provide the vehicle with a more aerodynamic shape or sporty profile. The body unit 92 may be coupled to the vehicle 10 to allow the rotational body section 16 to freely rotate. In accordance with one embodiment, the body unit 92 is attached to the rotational body section 16. This may allow the body unit 92 to rotate as the rotational body section 16 rotates in a clockwise or counterclockwise direction as a rider lean his/her body while turning the vehicle 10.

In the embodiment show in FIGS. 1-9, the vehicle 10 may have a plurality of fender units 94. The fender units 94 may be mounted over the wheels 44A and 44B to reduce the splashing of mud, water, and the like. In order for the body unit 92 to rotate, it may be necessary for the fender units 94 to be mounted on the suspension system 52 of the vehicle 10. This may allow the fender units 94 to be closer to the wheels 44A and 44B to reduce the splashing of mud, water, and the like while still allowing the body unit 92 to freely rotate within the maximum limits without hitting and or damaging any of the components of the vehicle 10.

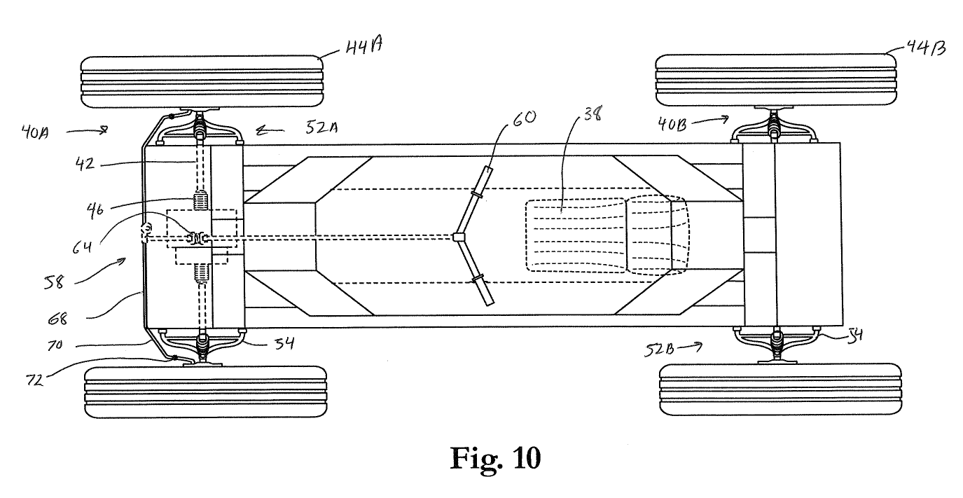

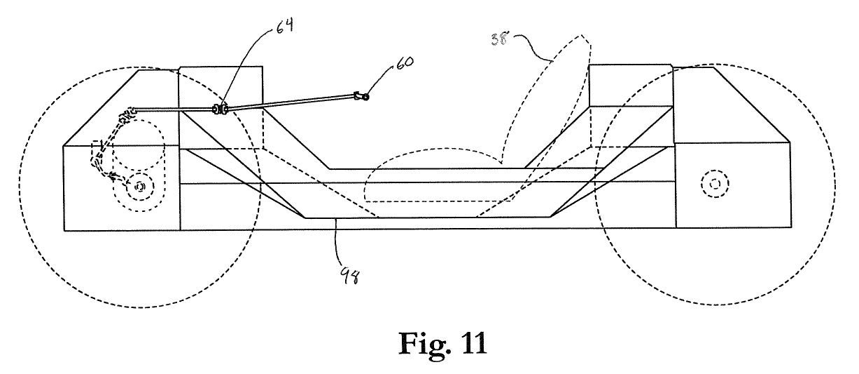

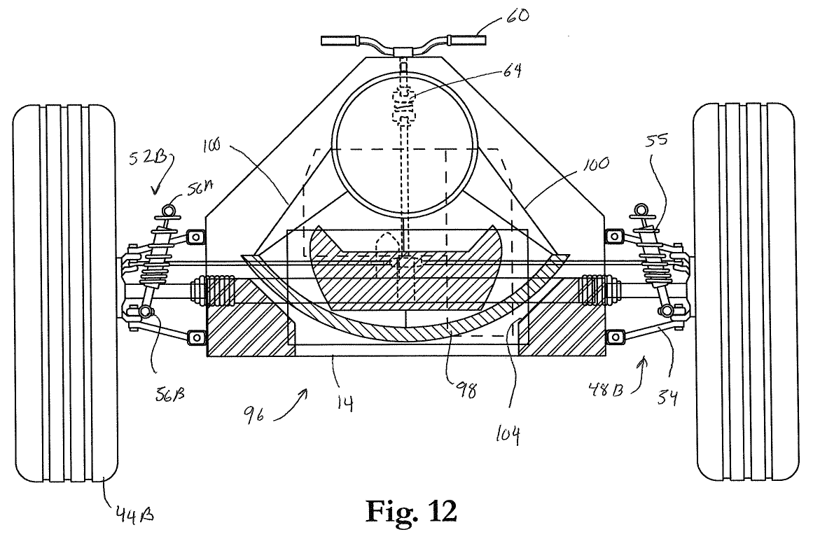

Referring to FIGS. 10-12, another embodiment of the vehicle 10′ is shown. The vehicle 10′ is similar to that previously shown. However, in vehicle 10′, the rotational body section 16 may be formed of a cradle member 96. The cradle member 96 may be rotationally coupled to the end members 14 of the main frame unit 12.

In the present embodiment, the cradle member 96 may be formed of a rounded bottom section 98. The rounded bottom section 98 extends approximately a length between the end members 14 and is rotatably coupled thereto. An arm member 100 may extend upward and inward from each end of the rounded bottom section 98. The arm members 100 may be coupled to a rotational device 102 which may allow the cradle member 96 to rotate in a clockwise or counterclockwise direction caused by the action of gravity and turning forces as the vehicle 10 turns.

The rotational device 102 may be a rotational connector used to attach the arm members 100 to the end members 14 of the main frame unit 12. Alternatively, the rotational device 102 may be an axle formed on each end members 14 of the main frame unit 12. The arm members 100 attached to the axle and the axle being rotatably coupled to the end members 14 of the main frame unit 12. The listing of the above is given as examples and should not be seen as to limit the scope of the present invention.

A seat 37 may be coupled to an interior section of the rounded bottom section 98 of the cradle member 96. By turning the vehicle wither left or right, the cradle member 96 will rotate in a clockwise or counterclockwise about the rotational device 102.

In the present embodiment, the center of gravity of the rider and saddle is below the axis of rotation, and will always align itself with the force vector acting upon it. In order to create a center of gravity below the axis of rotation, ballast is required. Thus, the vehicle 10′ may be an electric vehicle. In an electric vehicle, the vehicle 10′ requires an array of batteries that are of considerable weight, and that weight remains constant regardless of energy present. To turn the vehicle 10′, the rider turns the wheels exactly as he would while riding a motorcycle, but the rider's position will lean into the turn all on its own according to the force vector acting on the center of gravity.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A motorized vehicle comprising:
a frame;
a rotational section coupled to the frame;
an axle assembly coupled to the frame;
a steering system coupled to the axle assembly, the steering system having a flexible joint to adjust the steering assembly as the rotational section rotates in one of a clockwise or counterclockwise direction; and
an engine coupled to the axle assembly.

2. A motorized vehicle in accordance with claim 1, further comprising a suspension system coupled to the frame and the axle assembly.

3. A motorized vehicle in accordance with claim 1, further comprising a body section coupled to the rotational section.

4. A motorized vehicle in accordance with claim 1, further comprising a battery pack positioned on a bottom area of the rotational section and coupled to the engine.

5. A motorized vehicle in accordance with claim 4, further comprising a power control module coupled to the battery pack and the engine.

6. A motorized vehicle in accordance with claim 1, wherein the rotational section comprises:
an inner structure having a first end coupled to a first end of the frame and a second end coupled to a second end of the frame;
a plurality of roller races attached to the inner structure; and
an outer structure placed over the inner structure and in contact with the roller races, the outer structure rotating about the inner structure.

7. A motorized vehicle in accordance with claim 6, wherein the outer structure comprises:
a saddle brace coupled to a bottom area of the inner structure and in contact with the plurality of roller races; and
a saddle placed on a top section of the inner structure and in contact with the roller races and coupled to the saddle brace, the saddle and saddle brace rotating about the inner structure.

8. A motorized vehicle in accordance with claim 1, further comprising body support members coupled to the saddle to support a front and rear body parts and connects them to the rotational section.

9. A motorized vehicle in accordance with claim 1, wherein the rotational section comprises a cradle structure having a first end rotatably coupled to a first end of the frame and a second end rotatably coupled to a second end of the frame.

10. A motorized vehicle comprising:
a frame unit having a first end member and a second end member;
a rotational section coupled to the frame, wherein the rotational section comprises:
an inner structure having a first end coupled to a first end of the frame and a second end coupled to a second end of the frame;
a plurality of roller races attached to the inner structure; and
an outer structure placed over the inner structure and in contact with the roller races, the outer structure rotating about the inner structure;
an axle assembly coupled to the frame;
a suspension system coupled to the frame and the axle assembly;
a steering system coupled to the axle assembly, the steering system having a flexible joint to adjust the steering assembly as the rotational section rotates in one of a clockwise or counterclockwise direction;
an engine coupled to the axle assembly; and
a body section coupled to the rotational section.

11. A motorized vehicle in accordance with claim 10, further comprising a battery pack positioned on a bottom area of the rotational section and coupled to the engine, the engine being an electric engine.

12. A motorized vehicle in accordance with claim 11, further comprising a power control module coupled to the battery pack and the engine.

13. A motorized vehicle in accordance with claim 10, wherein the outer structure comprises:
a saddle brace coupled to a bottom area of the inner structure and in contact with the plurality of roller races; and
a saddle placed on a top section of the inner structure and in contact with the roller races and coupled to the saddle brace, the saddle and saddle brace rotating about the inner structure

14. A motorized vehicle in accordance with claim 13, further comprising body support members coupled to the saddle to support front and rear body parts and connects them to the rotational section.

15. A motorized vehicle comprising:
a frame unit having a first end member and a second end member;
a rotational section coupled to the frame, wherein the rotational section comprises a cradle structure having a first end rotatably coupled to a first end of the frame and a second end rotatably coupled to a second end of the frame;
an axle assembly coupled to the frame;
a steering system coupled to the axle assembly, the steering system having a flexible joint to adjust the steering assembly as the rotational section rotates in one of a clockwise or counterclockwise direction;
an engine coupled to the axle assembly; and
a body section coupled to the rotational section.

16. A motorized vehicle in accordance with claim 15 wherein the cradle structure comprises:
a rounded bottom section, the rounded bottom section extending from a first end member of the frame unit to a second end member of the frame unit;
a pair of arm members extending up and inward from each end of the rounded bottom section and coupled to one of the first end member of the frame unit to a second end member of the frame unit.

17. A motorized vehicle in accordance with claim 16 further comprising a suspension system coupled to the frame and the axle assembly.

18. A motorized vehicle in accordance with claim 16 further comprising a seat attached to an interior section of the rounded bottom section.

19. A motorized vehicle in accordance with claim 15, further comprising a battery pack coupled to the engine, the engine being an electric engine.

20. A motorized vehicle in accordance with claim 18, further comprising a power control module coupled to the battery pack and the engine.
